(19) United States
(12) Patent Application Publication
(10) Pub. No.: US 2024/0070561 A1
(43) Pub. Date: Feb. 29, 2024

(54) Service Business Management System

(71) Applicant: PTM Conte Corporation d/b/a Siena Ristorante, Stamford, CT (US)

(72) Inventors: Pasqualino Conte, Stamford, CT (US); Pietro Polini, Stamford, CT (US)

(21) Appl. No.: 18/455,471

(22) Filed: Aug. 24, 2023

Related U.S. Application Data
(60) Provisional application No. 63/373,417, filed on Aug. 24, 2022.

(51) Int. Cl. G06Q 10/02

(52) U.S. Cl. CPC G06Q 10/02

(57) ABSTRACT

A service business management system is provided which includes a service business computer with associated transport rules, a user device for transmitting a reservation request, a confirmation sent to the user after checking eligibility, a transport receipt associated with the confirmation, a tabulated service check associated with said confirmation, and a discounted service check generated by the business computer from the tabulated service check, the transport receipt, and a transport discount rule.

### TECHNICAL FIELD

The disclosure relates to a system providing patrons to service businesses, reduced checks to patrons, and business to ride share platforms. The technical solution is to link service checks to transport receipts using reservations systems.

### BACKGROUND

Mobile and web-based systems that allow patrons to reserve restaurant tables or other services at no cost have a substantial following. Participating restaurants or other service businesses often pay a monthly free and/or fee per patron to access the booking system, build out their profile, and collect patron data. Patrons also may earn points, discounts, or other rewards for use of the reservation system.

Mobile and web-based rideshare systems that allow passengers to arrange transportation and match them with drivers are even more ubiquitous. Passengers often pay a fee based on their itinerary and secondary factors. Passengers also may earn points, discounts, or other rewards for their use of the ride-share system.

Mobile and web-based delivery systems that allow customers to order goods including food and organize the delivery of the goods are often satellite services of rideshare companies. Customers typically pay a fee based on delivery itinerary and the merchant often also pays a fee based on the value of goods provided. While these services increase restaurant food business, they generally don't include in-person bar tickets or last-minute purchases and often require the merchant to forfeit a significant portion of their food sales revenue to the company offering the service.

Restaurants and service businesses in metropolitan areas often have little or no convenient and affordable parking for in-restaurant or service patrons. As restaurants recover from years of lost business due to the pandemic, additional outdoor seating designed to enhance restaurant capacity has led to a further reduction in available parking for service business patrons of all types.

Well-established service businesses face further obstacles as transportation to and from restaurants is difficult for older patrons. The challenges faced by such aging patrons are compounded by parking availability pressures and alternatively the cost of using rideshare systems.

Valet systems are employed by some restaurants to alleviate some of these business challenges, but those services too are extremely expensive for restaurants to hire or operate, and patrons are generally expected to pay tips.

What is needed for restaurants and other service businesses, therefore, is a cost-efficient solution that both reduces the burdens of in-person diners and service patrons that also enhances the quality of service offered by service businesses. Such a solution is also desired by patrons. Especially those patrons who drink alcohol, are older or uncomfortable driving in inclement weather, and/or who struggle to find convenient and inexpensive parking in urban areas.

### SUMMARY

Accordingly, it is an object of the disclosure to provide a service business management system which improves business volume by alleviating some or all patron transport issues at no or low cost to the patron.

Another object of the disclosure is to connect patron checks to transport costs, allowing service businesses to alleviate patron transport burdens in a cost-effective manner.

A further object of the disclosure is to utilize existing service business reservation systems to associate patron transport costs with patron service checks.

Still another object of the disclosure is to track patron's service business to analyze transport reimbursement impact on visits and/or service check size.

Still a further object is to allow service businesses to set parameters for transport reimbursement on a location and or patron basis.

Another further object is to seek third party reimbursement for at least a portion of service business transport costs by civic, governmental, environmental, business, or other groups focused on enhancing community.

These and other objects of the disclosure are achieved by providing a service business management system in accordance with the teachings herein. Businesses curate an initial list of patrons who are granted access to the system. Businesses also create transport rules which govern application of service check discounts based on transportation costs. The transport rules may incorporate factors such as trip distance, home location, number of simultaneous patrons or diners, day of the week, time of day, cost of transport, total amount of check or average historical check, amount of alcohol on check and many others that will be known to service business owners/managers.

Permitted patrons select a service business and make a service/table reservation request. If the request meets the business's eligibility and transport rules, the system generates a confirmation used by both the patron and the service business. The patron uses the confirmation to order transport services. The business uses the confirmation to tabulate a service check upon the patron's arrival.

Prior to the reservation time and day, a transportation request that is tied to the patron's service/table reservation is submitted to a transportation system. The system may send a reminder or notification to the patron so that they order transport from their current location, e.g., her home, with enough time that the ride will arrive to the service business in time for their appointment or table reservation. The system may automatically request transportation on behalf of the user. This enables service businesses to be prepared for the patron's arrival and enhances turnover timeliness.

Upon arrival to the service business, a transport receipt is sent from the patron/user's or system's transportation account to the service business, where it is linked to the reservation confirmation. In this regard, the user or system may have pre-populated her account with credentials for transportation systems e.g., Uber, Lyft, Curb, etc., of choice and permitted sharing of her ride data to one or more service businesses using the system.

Once the patron has entered the service business and is assigned a table, chair, or service provider, the patron's confirmation is used to tabulate a service check associated with the patron and their transport receipt. In this regard, the restaurant has pre-populated its system account with credentials for its point-of-sale (POS) system. The business POS system may in some cases share data with the service business's reservation system which may allow a service business using the system to pre-populate reservation system credentials instead of or in addition to POS system credentials to allow matching of reservation confirmations, transportation receipts, and tabulated service checks. In another embodiment, the system provides a basic table reservation and payment system to implement these features.

Once a patron is finished with dining or another service, the business's transportation rules—which may in some cases be patron specific—are applied to the service check and transport receipt. A discounted check is calculated for presentation to the patron. The service business may accept or modify the system's proposed discount before presenting the discounted check to the patron, preferably within the user's app for payment. In some cases it may be desired to require payment in the app to obtain the discount. As well, the restaurant POS will generally tabulate the full undiscounted check for table presentation, and comparison to the The service business management system disclosed herein benefits all users, and municipalities as well. Businesses attract more reservations and increase their level of service for patrons, enhancing the community. Patrons get discounted service checks and overcome obstacles to in-person dining without having to sacrifice points, benefits or other rewards of their reservation and transportation systems. Transport services such as ride-share businesses maintain or increase full-price customers. Table reservation systems used by diners and restaurants increase the volume of reservations.

### BRIEF DESCRIPTION OF THE DRAWINGS

FIG. 1 is a schematic diagram illustrating a service business management system.

FIG. 2 is a schematic diagram illustrating a patron device of the system of FIG. 1.

FIG. 3 is a schematic diagram illustrating a service business device of the system of FIG. 1.

FIG. 4 is a schematic diagram illustrating additional operational details of the system of FIG. 1.

FIG. 5 is a schematic diagram illustrating a solution to the technical problem of associating a patron transport receipt with a patron service check in the system of FIG. 1.

### DETAILED DESCRIPTION

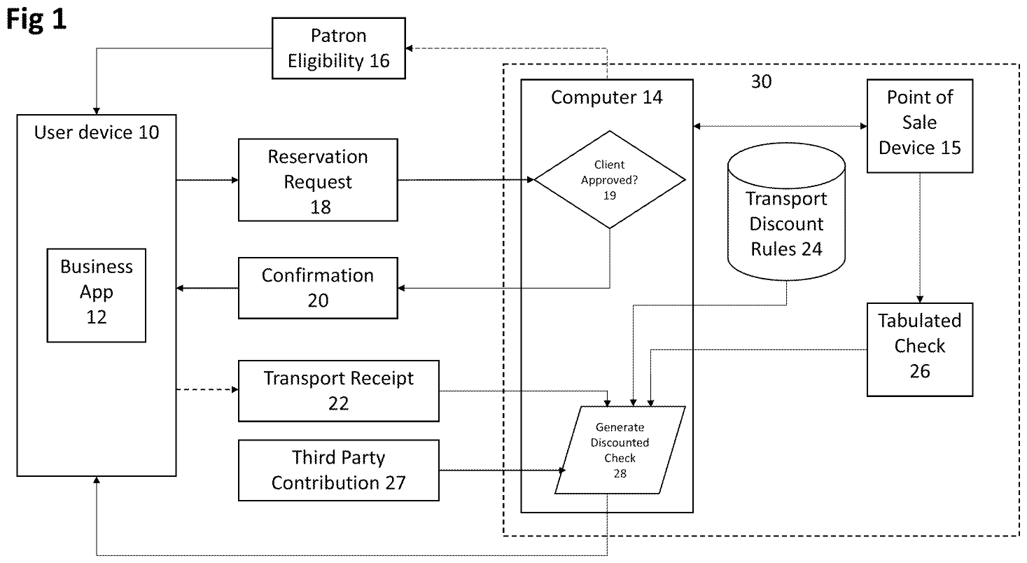

FIG. 1 depicts structures and operations pertaining to a service business management system. The system benefits any business offering personal services based on a reservation. Businesses that are already organized to accept online reservations may benefit the most. As well, businesses that sell alcohol and in particular restaurants with well-established clientele with limited parking may also significantly benefit.

A user device 10 which may be provided as myriad type mobile computers either has an application program or web site 12 which either links to or calls known service reservation systems, e.g., OpenTable, Resy, etc., and also links to or calls known transport service systems, e.g., Uber, Lyft, etc.

User device 10 may already be authenticated to the known reservation and/or transport systems (not shown), in which case those authentication details can be shared with app/web site 12 or a user's login details can be re-entered and stored in app/web site 12 for future use.

App/web site 12 may be open for any potential customer to use but, at least initially, is preferably limited to preferred customers of the service business that control eligibility to access and use the system. They can do this e.g., by providing electronic invites 16 or distributing cards (not shown) that have codes that allow either the download of the app/web site, or the creation of a single account on the app/website.

Once authenticated, a user of device 10 is in data communication with the Internet and a central computer 14 where it can use the service reservation credentials and transport credentials. Computer 14 may be one or more networked computers on the Internet, or it may be provided as part of a service business computer system 30 as shown by the dashed line in FIG. 1.

In either case, a service business patron can request a reservation 18 e.g., for a personal service at a salon or a table at a restaurant. Computer 14 confirms eligibility of the patron at 19 to use app/web site 12 to reserve services offered by the service business by checking a permitted patron list. This eligibility step may be made either via the patron's reservation system account, or the service business computing system, or manually by the service business. However, completed, a confirmation 20 is assigned to eligible requests if the service business is willing to provide the patron the requested service.

Reservation request 18 and confirmation 20 include data such as the identity of the patron, the date and time, the service requested, the party size, and any special requests made available by the service business it's reservation system for use by booking patrons. In the case of a restaurant, e.g., the booking may include details such as special events, table location, and the like.

As the date and time of the reservation approaches, a notification or reminder (not shown) can be provided to users via app/web site 12 so that patrons are less likely to miss their service appointments. Since the app/web site 12 includes the patron's addresses e.g., home, office or current location, and confirmation details 20, it can provide notifications or reminders, and can even order the patron's transportation to the service business so that they arrive on time. Whether app 12 orders the transport or just provides a function for the user to order the transport, the patron/user's of the system's transport authentication details may be used. The user pays for the trip in the event they fail to appear at the business and to the extent the discount offered does not exceed the transport cost. A transport receipt 22 is sent to computer 14 by the user's app or the system. Transport receipt 22 includes the confirmation details so that computer 14/30 can associate the transport receipt with the patron for later calculating a discounted service check 28.

Because business service computer 14 is in data communication with patron device 10, the service business manager can receive patron itinerary details, and may receive notifications related to the trip e.g., that the patron is enroute or about to arrive. This data allows the manager/owner to improve service by making sure a reserved service/table is ready on patron arrival, and also allows the manager/owner of the service establishment to anticipate their arrival and greet them at the door. In this regard, service business computer 14 may utilize the same or a companion application or web site to app 12. Patrons can use the app to manage service establishment reservations and transport, and service businesses can use the same or companion app to manage patrons.

On the patron's arrival to the service business, the owner/manager assigns the patron to a table in the case of a restaurant, to a hairdresser/aesthetician/masseuse in the case of a salon, or to another service provider depending on the business. Whether or not the service business is using a companion app/web site to app 12, this assignment can be as simple as dragging and dropping the patron's name from the reservation system to a point-of-sale (POS) system 15. Once this step is completed, the transport receipt 22 for the patron can be associated with a tabulated check 26. While not necessary, the reservation system used by both patron and service provider can be the means of associating the transport receipt 22 and tabulated check 26. The association can also be made in app 12 if it (or a companion app/web site) is accessed by the service business. Moreover, the POS system 15 could be used to associate the tabulated check and reservation, depending on integrations that may already exist in each of the various known systems used by service businesses. In another embodiment the system can include a simple table booking and payment system to implement the discounted check in a similar manner.

The system is designed to make it easier for patrons to travel to and enjoy services from local businesses. Accordingly, it is believed that use of app 12 will encourage them to visit more frequently and also to spend more money when they do visit. During a patron visit, a service check is tabulated as she orders goods and services. The tabulated check is normally accumulated, e.g., in the case of a restaurant on a POS system which also ties to the kitchen and possibly even to staff scheduling and inventory management.

Once the patron is ready to leave, computer 14/30 generates a discounted check 28 for presentation to the patron, preferably but necessarily via the app. To complete the calculation, computer 14/30 accesses transport discount rules 24 which are service business specific and may even be patron specific. For example, discount rules 24 may limit by geography and only apply to patron transport within a certain radius of the service business, may apply a ride fare dollar limit, may require that a patron travel from specific addresses such as her home or office, or may be calendar-based and only apply on certain days of the week when the service business is ordinarily not very busy, or may be time-based and only available at certain times of the day when the service business is otherwise not fully booked, or they may limit to special events, party size, tabulated check size, specific services or goods e.g., a bottle of wine in case of a restaurant.

Transport rules 24 are established by the service business when they set up their system account. The service business also provides basic information such as their address for transport purposes, and they may provide their reservation system authentication details, or their transport request can be passed directly through to the system. This allows patrons using app 12 to book service reservations on the service business's reservation system so that the transport receipt can later be associated with the patron's tabulated check.

The transport rules make a proposal about what portion or multiple of the transport receipt to deduct from the patron's tabulated check for consideration by the business owner. Note that the service business does not transfer any cash or other consideration to the patron, or to the patron's transport account, or to the patron's reservation account. Indeed, since the system contemplates use of known service and transport systems at full cost and expects to increase their business at all times of the day, these known systems may be willing to subsidize the patron's use of the system. Other third parties, e.g., municipalities eager to improve downtown traffic, cities with limited downtown parking and/or traffic congestion, environmental concerns, civic organizations, senior groups, safety advocates such as MADD and others, commercial property owners and managers, service business ownership/investment groups should all see the benefit of subsidizing safe transport to bring patrons to service businesses.

The final discounted check 28 is calculated from the tabulated check 26, the discount rules 24, the transport receipt 22, any third-party contributions 27, and finally service business discretion. The benefit to the patron is that they receive full-dollar value of all benefits without paying full-dollar. The benefit to the service business in addition to increasing patron volume and enhancing the reach of service, is that patrons who are well served and relaxed are likely to spend more money e.g., ordering another cocktail or glass of wine that they might have foregone if they had to drive home or pay for their ride in full. All parties benefit.

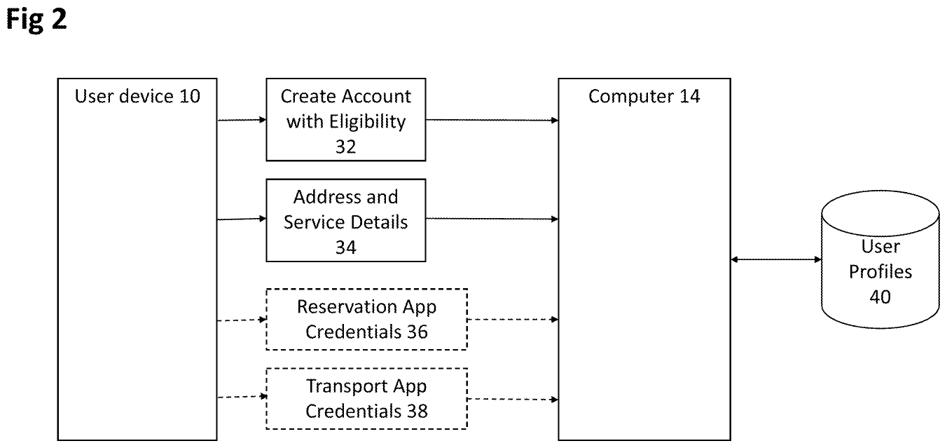

FIG. 2 illustrates additional details of a patron/user's account setup on computer 14. As discussed above, it is anticipated at least initially that users will require an invitation from a service business to use the system. So, account creation 32 will include an eligibility check and this check may need to be repeated for a user patron to access the system for transport discounts at other businesses. This could be implemented in several ways. New businesses could be alerted to system users at other businesses on the system. As well, business users could set varying transport rules for users eligible at other system businesses, or system businesses could focus on their own local and loyal customers and require other users to obtain eligibility access at each successive business added to the system.

Once eligibility is established at one or more system businesses, users input details about themselves and possibly also details about their service preferences at the eligible system service businesses. Addresses may be important because businesses may have transport rules relating to travel distance or home address and the like. And patrons may wish to make service preference requests like table linens for their visit, if e.g., the business is a restaurant. Other special occasion requests like a birthday cake can also be indicated on a one-time basis at the time a reservation is made, also e.g., if the business is a restaurant. Details such as birthdates may be added to permitted/eligible patron lists maintained by service businesses with accounts on the system.

Users may also provide their reservation app credentials 36, e.g., their Resy or OpenTable logins in case of restaurants, but also any other salon or service reservation account details, which allows patrons to continue accumulating loyalty points and other reservation system benefits even while using the system, and it may also provide an important data integration link with the service business since they will already have an account on the system that enables patrons to make service reservations.

Users may also provide their transport app credentials 38, e.g., their Uber or Lyft logins, or any other transport service account details. This allows patrons to continue accumulating loyalty points and other transport system benefits even while using the system, and it may also provide an important data integration link which allows the transport receipt to be sent to the service business for calculating the discounted check. Depending on the level of integration, the service business may also be able to order the patron's return trip home using their own account on app 12 or the companion app/web site.

This user data is stored on a database 40 accessible to computer 14/30 for use by service businesses authenticated to the system to determine eligibility 19, to confirm reservations 20, to associate transport receipts with tabulated checks, and to calculate discounted checks 28.

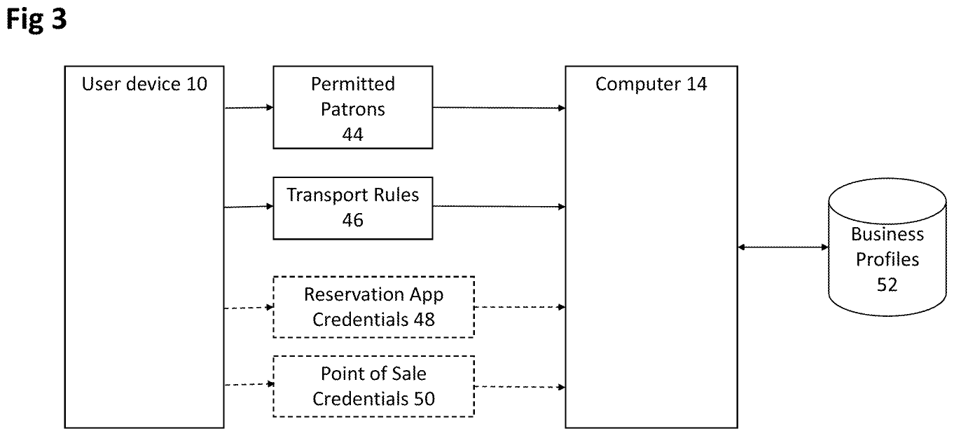

Turning now to FIG. 3, service businesses such as restaurants establish their own profiles on computer 14/30 of the system using a business device 17. Device 17 may be any mobile computing device. It may use app 12 or a companion app/web site. It may be combined, integrated or in data communication with or it may simply run as software right on computer 14/30. In any of these cases, service businesses may provide details about their locations and services offered, and they also provide a list of permitted/eligible patrons 44. For each permitted patron they may also collect data about their service preferences and track visit and spending habits. Seeing a patron's address will also assist them in designing transport rules which make use of the system by certain patrons viable for the service business. These transport rules 46 are stored on database 24 on a business-by-business basis, and depending on the desired granularity of the rules each business may desire to store them on a patron-by-patron basis. At 46, the service business enters its reservation app credentials for a known system that its customers likely already use to book services. These various pieces of service business data are stored in a service business profile database 52. Database 52 is used in part by patrons when they submit a reservation request 18.

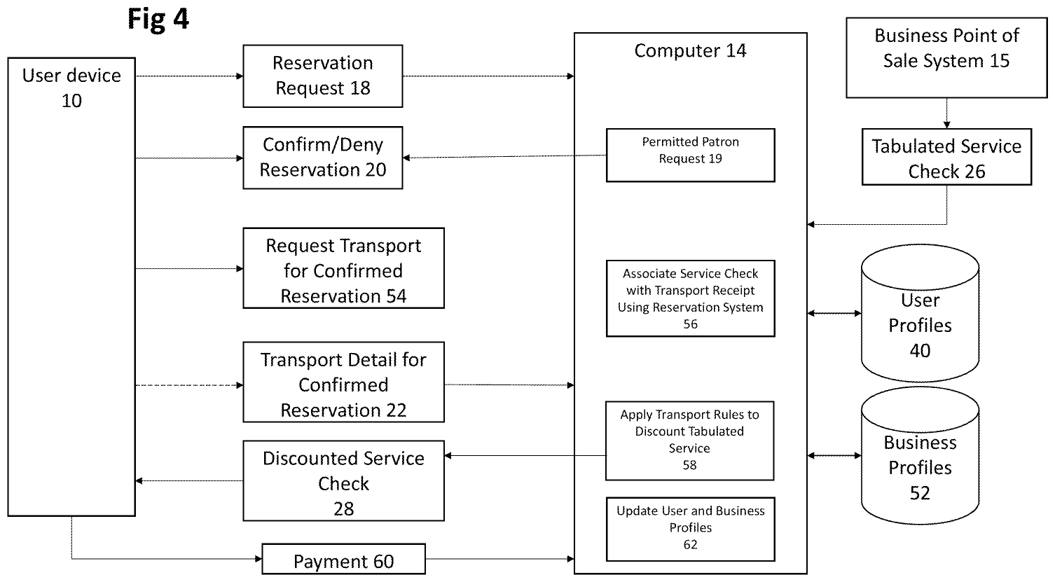

FIG. 4 illustrates some additional process steps. An eligible user authenticated to app 12 makes a reservations request at 18 using e.g., their mobile phone. After computer 14 confirms eligibility at 19, a confirmation 20 (or denial) of the request is returned to the user on device 10. The user or app may schedule transportation as appropriate in order to timely arrive to the reservation, or, when the reservation is imminent, the user or app 12 makes a transport request 54 to the service business via the user's or system's transport authentication. The service business may or may not have access to see their patron's transport progress, but transport detail 22 is sent to the service business showing the patrons transport cost once they have arrived.

Next, a service provider or service station (e.g., a table) is assigned to the patron on computer 14 at 56. Table assignment is one way to associate the transport cost for a known patron with their tabulated service check 26 generated by the service business POS system 15. At 58, the transport rules and any third-party subsidies are applied to the tabulated service check and the appropriate amount or all or two times the transport costs are proposed to be deducted, computer 14 generates a discounted check 28. Although not necessary, discounted check may be forwarded electronically to user device 10 for payment 60 and to verify the transport discount. Note that the full tabulated check may be printed and presented to the client for payment 60 in any manner accepted by the service business POS system. If the POS is integrated by an API or otherwise to the service business reservation system, then the business owner can track tabulated versus discounted checks and may tie them to transport receipts on a patron-by-patron basis. This allows the service business to adjust their transport discount rules over time to insure a positive financial outcome of using the system. Finally at 58, the user profile database 40 and service business profile database 52 are updated with the completed patron transaction. It may be desirable to require user's/patron's to pay in the app in order to obtain the discount.

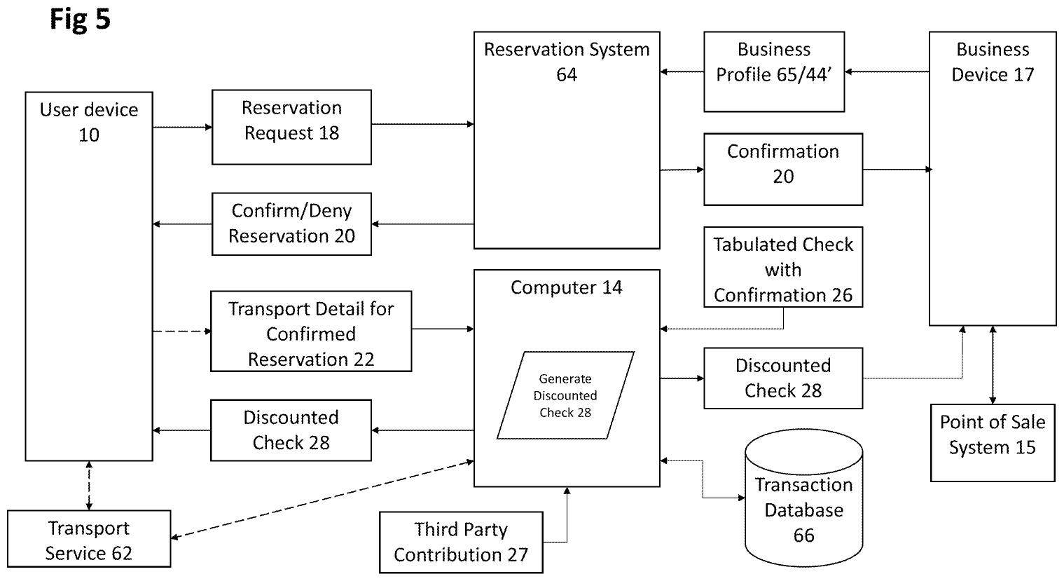

FIG. 5 illustrates a solution to the technical problem of associating a patron's transport service receipt with their tabulated service check. Reservation system 64 plays an important role in the technical solution because both the patron and the business authenticate to a common reservation system. This may be a known third-party system or a system-provided table booking engine. Either allows the business to create a profile 65/44′ with details about the services offered and the reservations available, and it allows the patron to request a reservation at 18. Once the request is confirmed at 20 it can be communicated to both authenticated parties, namely user device 10 and business device 17. Confirmation 20 can also be stored on transaction database 66 in data communication with computer 14.

Transaction database 66 provides placeholder storage which may be temporary or permanent so that user device 10 and business device 17 can share information. Database 66 can be implemented using many technologies well known to those of ordinary skill in developing mobile/web applications.

After the patron arranges travel with her own or the system's account on transport service 62 to the service business to fulfill their reservation, a transport receipt 22 for the cost of transport and possible other details such as distance, number of passengers, and the like, is forwarded to computer 14 for storage on transaction database 66 in association with the particular confirmation 20.

Upon arrival of a patron at the service business, device 17 which is authenticated to POS system 15, tabulates a service check 26. Like the transport receipt 22, service check 26 is forwarded to computer 14 for storage on transaction database 66 in association with the particular confirmation 20. When the patron is ready to leave, transport rules provided by the service business are used by computer 14 together with the tabulated check and transport receipt retrieved from transaction database 66 on a confirmation-by-confirmation basis to calculate a proposed discounted check 28 which can be presented back to both business device 17 for approval or modification, and to user device 10 for payment.

It will be apparent to one of ordinary skill in the art that the system described herein with reference to the figures is as an example of how to implement the disclosure and not a required or detailed production specification. A knowledgeable service business owner and programmer may elect to implement the disclosure in a different way to achieve the same benefit.

What is claimed is:

1. A restaurant management system, comprising:
a user device with a restaurant app installed;
a computer having a list of permitted patrons;
at least one transport rule accessible by said computer;
a reservation request transmitted from said user device to said computer;
a confirmation sent, after checking patron permission, from said computer to said user device in response to said reservation request;
a transportation receipt received by said computer and associated with said confirmation;
a table check tabulated by said computer and associated with said confirmation; and
a discounted check calculated by said computer from said at least one transport rule, said table check, and said transportation receipt.

2. The restaurant management system of claim 1 wherein said computer presents said discounted check to said user device for payment.

3. The restaurant management system of claim 1 further comprising a third-party contribution, and wherein said third party contribution is also used to calculate said discounted check.

4. The restaurant management system of claim 3 wherein said third party contribution is provided form the group comprising: a transport service subsidy, a government subsidy, a non-profit subsidy, a business association subsidy, a business software subsidy, and combinations of these.

5. The restaurant management system of claim 1 wherein the business approves the discounted check before it is presented to the patron for payment.

6. A service business management system, comprising:
a service business computer;
a database of transport discount rules in communication with said service business computer;
a user device for transmitting a reservation request to said service business computer;
a confirmation sent to the user after checking patron eligibility;
a transport receipt received at said service business computer associated with said confirmation;
a service check tabulated by said service business computer and associated with said confirmation;
a discounted service check calculated by said service business computer from said tabulated service check, said transport receipt, and transport discount rules retrieved from said database.

7. The service business management system of claim 6 wherein said tabulated service check and said discounted service check are stored in a service business CRM system.

8. The service business management system of claim 6 wherein said service business computer is a restaurant computer.

9. The service business management system of claim 6 wherein said discounted service check is sent by said service business computer to said user device for payment.

10. The service business management system of claim 6 wherein said service business computer is connected to a transport computer by API.

11. The service business management system of claim 6 wherein said user device is connected to a transport computer by API.

12. The service business management system of claim 6 wherein said service business computer is connected to a reservation computer by API.

13. The service business management system of claim 6 wherein said service business computer distributes patron eligibility credentials to user devices.

14. The service business management system of claim 6 wherein said service business computer is provided as a phone or tablet.

15. The service business management system of claim 6 wherein patron eligibility is determined by CRM functionality associated with said service business computer.

16. A service business management system, comprising:
a patron device having a list of available services;
a business device having a list of permitted patrons;
a reservation system accessible by said business device and said patron device;
at least one transport rule accessible by said business device;
a reservation request transmitted from said patron device to said reservation system;
a confirmation sent, after an eligibility check, from said reservation system to said patron device in response to said reservation request;
a patron transport receipt received by said business device;
a service check accumulated by the patron at the service business; and
a discounted service check presented to the patron for payment, said discounted service check calculated by said business device from said at least one transport rule, said service check, and said transport receipt; and
wherein said reservation system associates said transport receipt with said service check.

17. The service business management system of claim 16 wherein said transport rules are generated on said business device.

18. The service business management system of claim 16 wherein patron eligibility is performed on said business device.

19. A service business management system comprising:
a reservation system having customers and to create service appointments at businesses;
a computer in data communication with said reservation system;
a database storing confirmations relating to service appointments made on said reservation system;
a plurality of transport receipts for delivery of customers to businesses, said transport receipts stored on said database according to confirmation;
a plurality of checks tabulated for services ordered by customers, said tabulated service checks stored on said database according to confirmation;
at least one transport discount rules accessible to said computer; and
a discounted check generated by deducting, according to said at least one transport discount rule, at least a portion of said transport receipt from the tabulated service check sharing the same confirmation.

20. The service business management system of claim 19 further comprising an application program accessible by both the customers and the businesses, said application program in data communication with said database.

21. The service business management system of claim 20 further comprising a plurality of mobile computing devices, each of said mobile computing devices executing said application program.

22. The service business management system of claim 21 wherein customers use one of said mobile computing devices to request the service appointment.

23. The service business management system of claim 21 wherein business uses one of said mobile computing devices to confirm service appointment requests.

24. The service business management system of claim 20 wherein said computer and said database are provided as Internet-based services.
